(19) United States
(12) Patent Application Publication
(10) Pub. No.: US 2025/0009472 A1
(43) Pub. Date: Jan. 9, 2025

(54) SYSTEM AND METHOD FOR GENERATING A FINAL POSITION OF TEETH FOR ORTHODONTIC TREATMENT

(71) Applicant: SDC U.S. SmilePay SPV, Nashville, TN (US)

(72) Inventors: EVGENY SERGEEVICH GORBOVSKOY, Moscow (RU); ESTEBAN ZAMORA SBRAVATTI, Barcelona (ES); SERGEY NIKOLSKIY, Nashville, TN (US); ANDREY LVOVICH EMELYANENKO, Moscow (RU); ALEKSEI VALERIEVICH KABYKIN, Moscow (RU); ANTON OLEGOVICH KALININ, Moscow (RU); MAXIM ALEXANDROVICH BOGATYREV, Moscow (RU)

(73) Assignee: SDC U.S. SmilePay SPV, New York, NY (US)

(21) Appl. No.: 18/710,040

(22) PCT Filed: Nov. 15, 2021
(86) PCT No.: PCT/RU2021/000502

§ 371 Date: May 14, 2024

(51) Int. Cl. A61C 7/00; A61C 13/34

(52) U.S. Cl. CPC A61C 7/002; A61C 13/34; A61C 2007/004

(57) ABSTRACT

Systems and methods for setting teeth final positions in a treatment plan include: receiving a first 3D representation of a dentition in an initial position, distributing one or more first teeth in the first 3D representation in a mesial-distal direction, modifying a position of one or more second teeth of the plurality of teeth along a maxillary-mandibular axis based on a determined cutting edge, shifting one or more third teeth of the plurality of teeth in the first 3D representation towards a determined arch curve, and generating a second 3D representation by moving one or more fourth teeth of the plurality of teeth to minimize interproximal contacts between the plurality of teeth along the arch curve.

### TECHNICAL FIELD

The present disclosure relates generally to the field of dental treatment, and more specifically, to systems and methods for generating a treatment plan for orthodontic treatment.

### BACKGROUND

Dental impressions and associated physical or digital reproductions of a patient's teeth can be used by dentists or orthodontists to diagnose or treat an oral condition, such as the misalignment of the patient's teeth. Typically, to receive treatment for a misalignment, a patient visits a dentist that specializes in such treatment. The patient may visit the dentist for an initial consultation, a first appointment where the patient actually begins treatment, and numerous follow-up appointments, each with the same dentist. The dentist may follow up the initial consultation appointment by creating a treatment plan for a patient. The treatment plan may include one or more images such as three-dimensional renderings of a planned final positioning of the teeth. Typically, dentists or technicians manually create these images by moving individual teeth in increments to a final position, or by manually moving individual teeth directly to a final position and then determining the increments needed to reach the final position. This process is tedious, time consuming, and inefficient. Additionally, by relying on individuals to manually generate final positions, existing systems yield unpredictable and inconsistent results which vary on a case-by-case basis due to the subjectivity of the individual performing the manual process.

### SUMMARY

In one aspect, this disclosure is directed to a method. The method includes receiving, by one or more processors, a first three-dimensional (3D) representation of a dentition in an initial position, the first 3D representation including representations of a plurality of teeth of the dentition, distributing, by the one or more processors, one or more first teeth in the first 3D representation in a mesial-distal direction based on interproximal contacts between respective adjacent teeth of the plurality of teeth in the dentition, determining, by the one or more processors, a cutting edge along an occlusal plane for one or more anterior teeth of the plurality of teeth in the first 3D representation, modifying, by the one or more processors, a position of one or more second teeth of the plurality of teeth along a maxillary-mandibular axis based on the cutting edge, determining, by the one or more processors, an arch curve for the plurality of teeth in the first 3D representation, shifting, by the one or more processors, one or more third teeth of the plurality of teeth in the first 3D representation towards the arch curve, and generating, by the one or more processors, a second 3D representation by moving one or more fourth teeth of the plurality of teeth along the occlusal plane in a mesial-distal or buccal-lingual direction to minimize interproximal contacts between the plurality of teeth along the arch curve.

In another aspect, this disclosure is directed to a system. The system includes one or more processors and a memory storing instructions. The instructions when executed by the one or more processors cause the one or more processors to receive a first three-dimensional (3D) representation of a dentition in an initial position, the first 3D representation including representations of a plurality of teeth of the dentition, distribute one or more first teeth in the first 3D representation in a mesial-distal direction based on interproximal contacts between respective adjacent teeth of the plurality of teeth in the dentition, determine a cutting edge along an occlusal plane for one or more anterior teeth of the plurality of teeth in the first 3D representation, modify a position of one or more second teeth of the plurality of teeth along a maxillary-mandibular axis based on the cutting edge, determine an arch curve for the plurality of teeth in the first 3D representation, shift one or more third teeth of the plurality of teeth in the first 3D representation towards the arch curve, and generate a second 3D representation by moving one or more fourth teeth of the plurality of teeth along the occlusal plane in a mesial-distal or buccal direction to minimize interproximal contacts between the plurality of teeth along the arch curve.

In yet another aspect, this disclosure is directed to a non-transitory computer readable medium that stores instructions. The instructions, when executed by one or more processors, cause the one or more processors to receive a first three-dimensional (3D) representation of a dentition in an initial position, the first 3D representation including representations of a plurality of teeth of the dentition, distribute one or more first teeth in the first 3D representation in a mesial-distal direction based on interproximal contacts between respective adjacent teeth of the plurality of teeth in the dentition, determine a cutting edge along an occlusal plane for one or more anterior teeth of the plurality of teeth in the first 3D representation, modify a position of one or more second teeth of the plurality of teeth along a maxillary-mandibular axis based on the cutting edge, determine an arch curve for the plurality of teeth in the first 3D representation, shift one or more third teeth of the plurality of teeth in the first 3D representation towards the arch curve, and generate a second 3D representation by moving one or more fourth teeth of the plurality of teeth along the occlusal plane in a mesial-distal or buccal direction to minimize interproximal contacts between the plurality of teeth along the arch curve

Various other embodiments and aspects of the disclosure will become apparent based on the drawings and detailed description of the following disclosure.

### BRIEF DESCRIPTION OF THE DRAWINGS

FIG. 1 shows a system for orthodontic treatment, according to an illustrative embodiment.

FIG. 2 shows a process flow of generating a treatment plan, according to an illustrative embodiment.

FIG. 3 shows a top-down simplified view of a model of a dentition, according to an illustrative embodiment.

FIG. 4 shows a perspective view of a three-dimensional model of the dentition of FIG. 3, according to an illustrative embodiment.

FIG. 5 shows a trace of a gingiva-tooth interface on the model shown in FIG. 3, according to an illustrative embodiment.

FIG. 6 shows selection of teeth in a tooth model generated from the model shown in FIG. 5, according to an illustrative embodiment.

FIG. 7 shows a segmented tooth model of an initial position of the dentition shown in FIG. 3, according to an illustrative embodiment.

FIG. 8 shows a target final position of the dentition from the initial position of the dentition shown in FIG. 7, according to an illustrative embodiment.

FIG. 9 shows a series of stages of the dentition from the initial position shown in FIG. 7 to the target final position shown in FIG. 8, according to an illustrative embodiment.

FIG. 10 shows an example user interface used to apply one or more tools that automatically shift the position of teeth of the dentition shown in FIG. 3, according to an illustrative embodiment.

FIG. 11 shows a diagram of a method for generating a 3D representation of a final position for a plurality of teeth within a treatment plan, according to an illustrative embodiment.

FIG. 12 shows a perspective view of a three-dimensional model of the dentition of FIG. 3 including directions and orientations of the dentition, according to an illustrative embodiment.

FIG. 13A shows a segmented tooth model of a first position of the dentition shown in FIG. 3 prior to execution of a distribution process, according to an illustrative embodiment.

FIG. 13B shows a segmented tooth model of a second position of the dentition shown in FIG. 13A following execution of the distribution process, according to an illustrative embodiment.

FIG. 14A shows a segmented tooth model of a before position of the dentition shown in FIG. 3 prior to execution of a leveling process, according to an illustrative embodiment.

FIG. 14B shows a segmented tooth model of an after position of the dentition shown in FIG. 3 following execution of the leveling process, according to an illustrative embodiment.

FIG. 14C shows a user interface for selecting a guide tooth on a three-dimensional model of a dentition for the leveling process, according to an illustrative embodiment.

FIG. 14D shows a view of the three-dimensional model shown in FIG. 14C following execution of the leveling process, according to an illustrative embodiment.

FIG. 15A shows a segmented tooth model of a before position of the dentition shown in FIG. 3 prior to execution of an arch form process, according to an illustrative embodiment.

FIG. 15B shows a segmented tooth model of an after position of the dentition shown in FIG. 3 following execution of the arch form process, according to an illustrative embodiment.

FIG. 15C shows a user interface for defining an arch line for a three-dimensional model of a dentition, according to an illustrative embodiment.

FIG. 15D shows a user interface including the three-dimensional model shown in FIG. 15C following defining the arch line, according to an illustrative embodiment.

FIG. 15E shows a view of the three-dimensional model shown in FIG. 15C and FIG. 15D following execution of the arch form process, according to an illustrative embodiment.

FIG. 16A shows a segmented tooth model of a before position of the dentition shown in FIG. 3 prior to execution of an arch design process, according to an illustrative embodiment.

FIG. 16B shows a segmented tooth model of an after position of the dentition shown in FIG. 3 following execution of the arch design process, according to an illustrative embodiment.

FIG. 16C shows a user interface including a three-dimensional model for executing the arch design process, according to an illustrative embodiment.

FIG. 16D shows a view of the three-dimensional model shown in FIG. 16C following execution of the arch design process, according to an illustrative embodiment.

### DETAILED DESCRIPTION

The present disclosure is directed to systems and methods for generating a treatment plan for orthodontic treatment. A medical provider (e.g., dentist, oral surgeon, dental technician, etc.) may create a treatment plan that describes the final positioning of a patient's teeth. In some embodiments, the treatment plan may include three-dimensional (3D) representations that show the final positioning of the patient's teeth. Typically, medical providers may create these 3D representations in computer aided design (CAD) modeling software by manually moving each tooth into a desired position using small movements according to their own subjective views and preferences. As a result, similarly-situated patients may receive different treatments and different outcomes with their teeth having different subjective final positions depending on the particular medical provider.

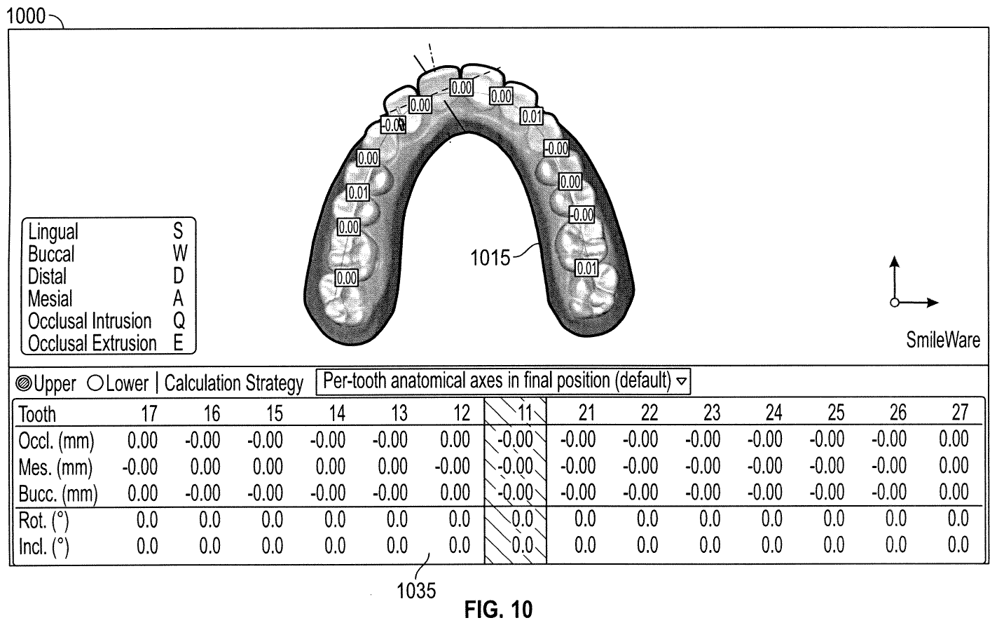

According to the embodiments of the present solution, a final position of a patient's dentition may be automatically derived or determined. Such implementations and embodiments may provide more uniform and objective treatment, thereby eliminating subjective considerations by a medical provider in generating the final position of the patient's teeth. Additionally, the systems and methods described herein may expedite the process of generating a final position of the patient's teeth. For example, traditional treatment planning systems rely on a subjective determination of aesthetics and what individual providers may deem as a proper final position. According to the systems and methods described herein, the computing devices execute various rules and executables for performing processes for determining, deriving, or otherwise generating a final position of a patient's dentition. The systems and methods described herein produce accurate and objective final positions that previously would be subjectively determined by humans and deviate on a case-by-case basis. As such, the systems and methods described herein improve upon current final tooth position processes by implementing various rules and executables which are based on data obtained from three-dimensional data of the patient's dentition and specific to performing a computerized final position process that would not otherwise be performed by a human performing a manual final position process. For example, by executing the various rules and executables described herein on a three-dimensional model of a patient's dentition (such as the distribution process, leveling process, arch form process, and arch design process described herein), the final position of the patient's dentition may be both aesthetically pleasing and objectively derived based on data of the patient's dentition according to the objective rules, rather than being based on a subjective determination from a treating professional or individual provider. As such, since the final position is aesthetically pleasing and objectively derived, the systems and methods described herein improve the process of generating final positions for treatment plans over subjective determinations of treatment plans previously performed. Additional technical advantages of the present solution are described in greater detail below with reference to FIGS. 10-16D.

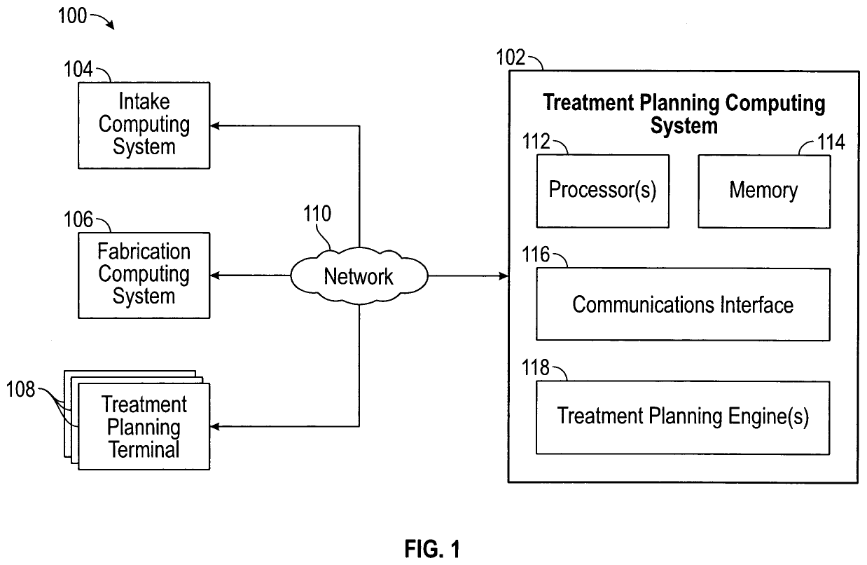

Referring to FIG. 1, a system 100 for orthodontic treatment is shown, according to an illustrative embodiment. As shown in FIG. 1, the system 100 includes a treatment plan computing system 102 communicably coupled to an intake computing system 104, a fabrication computing system 106, and one or more treatment planning terminals 108. In some embodiments, the treatment plan computing system 102 may be or may include one or more servers which are communicably coupled to a plurality of computing devices. In some embodiments, the treatment plan computing system 102 may include a plurality of servers, which may be located at a common location (e.g., a server bank) or may be distributed across a plurality of locations. The treatment plan computing system 102 may be communicably coupled to the intake computing system 104, fabrication computing system 106, and/or treatment planning terminals 108 via a communications link or network 110 (which may be or include various network connections configured to communicate, transmit, receive, or otherwise exchange data between addresses corresponding to the computing systems 102, 104, 106). The network 110 may be a Local Area Network (LAN), a Wide Area Network (WAN), a Wireless Local Area Network (WLAN), an Internet Area Network (IAN) or cloud-based network, etc. The network 110 may facilitate communication between the respective components of the system 100, as described in greater detail below.

The computing systems 102, 104, 106 include one or more processing circuits, which may include processor(s) 112 and memory 114. The processor(s) 112 may be a general purpose or specific purpose processor, an application specific integrated circuit (ASIC), one or more field programmable gate arrays (FPGAs), a group of processing components, or other suitable processing components. The processor(s) 112 may be configured to execute computer code or instructions stored in memory 114 or received from other computer readable media (e.g., CDROM, network storage, a remote server, etc.) to perform one or more of the processes described herein. The memory 114 may include one or more data storage devices (e.g., memory units, memory devices, computer-readable storage media, etc.) configured to store data, computer code, executable instructions, or other forms of computer-readable information. The memory 114 may include random access memory (RAM), read-only memory (ROM), hard drive storage, temporary storage, non-volatile memory, flash memory, optical memory, or any other suitable memory for storing software objects and/or computer instructions. The memory 114 may include database components, object code components, script components, or any other type of information structure for supporting the various activities and information structures described in the present disclosure. The memory 114 may be communicably connected to the processor 112 via the processing circuit, and may include computer code for executing (e.g., by processor(s) 112) one or more of the processes described herein.

The treatment plan computing system 102 is shown to include a communications interface 116. The communications interface 116 can be or can include components configured to transmit and/or receive data from one or more remote sources (such as the computing devices, components, systems, and/or terminals described herein). In some embodiments, each of the servers, systems, terminals, and/or computing devices may include a respective communications interface 116 which permit exchange of data between the respective components of the system 100. As such, each of the respective communications interfaces 116 may permit or otherwise enable data to be exchanged between the respective computing systems 102, 104, 106. In some implementations, communications device(s) may access the network 110 to exchange data with various other communications device(s) via cellular access, a modem, broadband, Wi-Fi, satellite access, etc. via the communications interfaces 116.

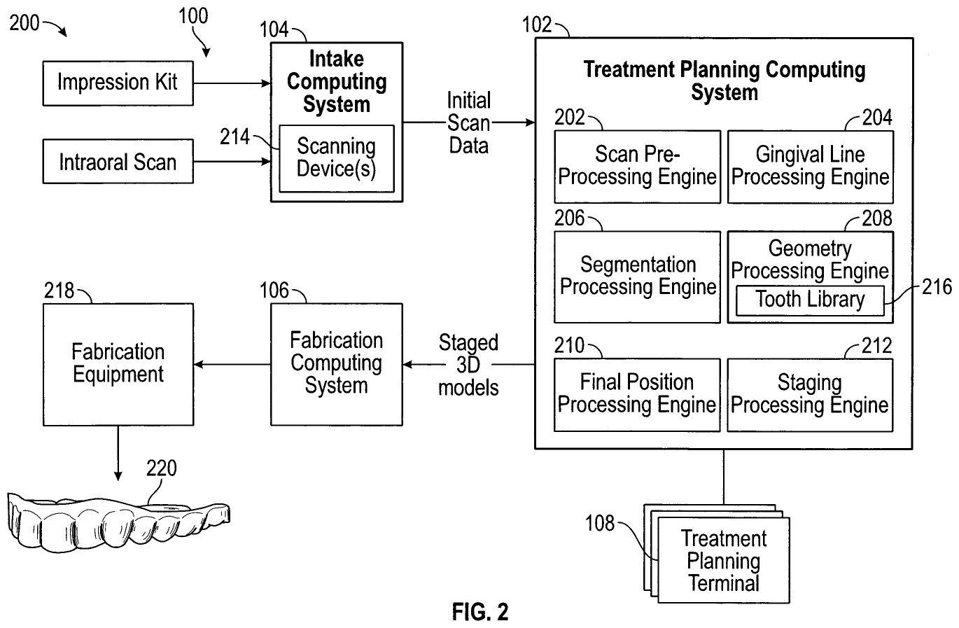

Referring now to FIG. 1 and FIG. 2, the treatment planning computing system 102 is shown to include one or more treatment planning engines 118. Specifically, FIG. 2 shows a treatment planning process flow 200 which may be implemented by the system 100 shown in FIG. 2, according to an illustrative embodiment. The treatment planning engine(s) 118 may be any device(s), component(s), circuit(s), or other combination of hardware components designed or implemented to receive inputs for and/or automatically generate a treatment plan from an initial three-dimensional (3D) model of a dentition. In some embodiments, the treatment planning engine(s) 118 may be instructions stored in memory 114 which are executable by the processor(s) 112. In some embodiments, the treatment planning engine(s) 118 may be stored at the treatment planning computing system 102 and accessible via a respective treatment planning terminal 108. As shown in FIG. 2, the treatment planning computing system 102 may include a scan pre-processing engine 202, a gingival line processing engine 204, a segmentation processing engine 206, a geometry processing engine 208, a final position processing engine 210, and a staging processing engine 212. While these engines 202-212 are shown in FIG. 2, it is noted that the system 100 may include any number of treatment planning engines 118, including additional engines which may be incorporated into, supplement, or replace one or more of the engines shown in FIG. 2.

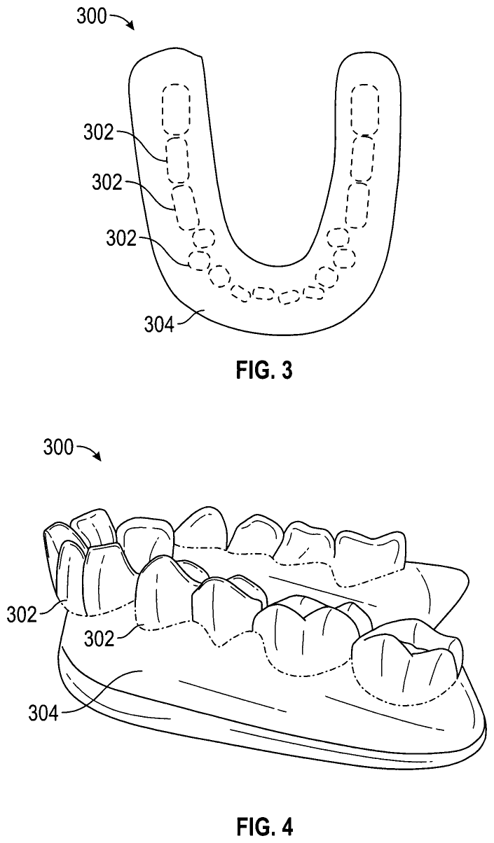

Referring to FIG. 2-FIG. 4, the intake computing system 104 may be configured to generate a 3D model of a dentition. Specifically, FIG. 3 and FIG. 4 show a simplified top-down view and a side perspective view of a 3D model of a dentition, respectively, according to illustrative embodiments. In some embodiments, the intake computing system 104 may be communicably coupled to or otherwise include one or more scanning devices 214. The intake computing system 104 may be communicably coupled to the scanning devices 214 via a wired or wireless connection. The scanning devices 214 may be or include any device, component, or hardware designed or implemented to generate, capture, or otherwise produce a 3D model 300 of an object, such as a dentition or dental arch. In some embodiments, the scanning devices 214 may include intraoral scanners configured to generate a 3D model of a dentition of a patient as the intraoral scanner passes over the dentition of the patient. For example, the intraoral scanner may be used during an intraoral scanning appointment, such as the intraoral scanning appointments described in U.S. Provisional Patent Appl. No. 62/660,141, titled “Arrangements for Intraoral Scanning,” filed Apr. 19, 2018, and U.S. patent application Ser. No. 16/130,762, titled “Arrangements for Intraoral Scanning,” filed Sep. 13, 2018. In some embodiments, the scanning devices 214 may include 3D scanners configured to scan a dental impression. The dental impression may be captured or administered by a patient using a dental impression kit similar to the dental impression kits described in U.S. Provisional Patent Appl. No. 62/522,847, titled “Dental Impression Kit and Methods Therefor,” filed Jun. 21, 2017, and U.S. patent application Ser. No. 16/047,694, titled “Dental Impression Kit and Methods Therefor,” filed Jul. 27, 2018, the contents of each of which are incorporated herein by reference in their entirety. In these and other embodiments, the scanning devices 214 may generally be configured to generate a 3D digital model of a dentition of a patient. The scanning device(s) 214 may be configured to generate a 3D digital model of the upper (i.e., maxillary) dentition and/or the lower (i.e., mandibular) dentition of the patient. The 3D digital model may include a digital representation of the patient's teeth 302 and gingiva 304. The scanning device(s) 214 may be configured to generate 3D digital models of the patient's dentition prior to treatment (i.e., with their teeth in an initial position). In some embodiments, the scanning device(s) 214 may be configured to generate the 3D digital models of the patient's dentition in real-time (e.g., as the dentition/impression) is scanned. In some embodiments, the scanning device(s) 214 may be configured to export, transmit, send, or otherwise provide data obtained during the scan to an external source which generates the 3D digital model, and transmits the 3D digital model to the intake computing system 104. In some embodiments, the intake computing system 104 is configured to generate the 3D digital model from one or more 2D images of the patient's dentition. For example, the patient themselves or someone else can capture one or more images of the patient's dentition using a digital camera, such as a camera system on a mobile phone or tablet, and then transmit or upload the one or more images to the intake computing system 104 for processing into the 3D digital model. The images captured by the patient, or someone assisting the patient, can be 2D photographs, videos, or a 3D photograph.

The intake computing system 104 may be configured to transmit, send, or otherwise provide the 3D digital model to the treatment planning computing system 102. In some embodiments, the intake computing system 104 may be configured to provide the 3D digital model of the patient's dentition to the treatment planning computing system 102 by uploading the 3D digital model to a patient file for the patient. The intake computing system 104 may be configured to provide the 3D digital model of the patient's upper and/or lower dentition at their initial (i.e., pre-treatment) position. The 3D digital model of the patient's upper and/or lower dentition may together form initial scan data which represents an initial position of the patient's teeth prior to treatment.

The treatment planning computing system 102 may be configured to receive the initial scan data from the intake computing system 104 (e.g., from the scanning device(s) 214 directly, indirectly via an external source following the scanning device(s) 214 providing data captured during the scan to the external source, etc.). As described in greater detail below, the treatment planning computing system 102 may include one or more treatment planning engines 118 configured or designed to generate a treatment plan based on or using the initial scan data.

Referring to FIG. 2, the treatment planning computing system 102 is shown to include a scan pre-processing engine 202. The scan pre-processing engine 202 may be or include any device(s), component(s), circuit(s), or other combination of hardware components designed or implemented to modify, correct, adjust, or otherwise process initial scan data received from the intake computing system 104 prior to generating a treatment plan. The scan pre-processing engine 202 may be configured to process the initial scan data by applying one or more surface smoothing algorithms to the 3D digital models. The scan pre-processing engine 202 may be configured to fill one or more holes or gaps in the 3D digital models. In some embodiments, the scan pre-processing engine 202 may be configured to receive inputs from a treatment planning terminal 108 to process the initial scan data. For example, the scan pre-processing engine 202 may be configured to receive inputs to smooth, refine, adjust, or otherwise process the initial scan data.

The inputs may include a selection of a smoothing processing tool presented on a user interface of the treatment planning terminal 108 showing the 3D digital model(s). As a user of the treatment planning terminal 108 selects various portions of the 3D digital model(s) using the smoothing processing tool, the scan pre-processing engine 202 may correspondingly smooth the 3D digital model at (and/or around) the selected portion. Similarly, the scan pre-processing engine 202 may be configured receive a selection of a gap filling processing tool presented on the user interface of the treatment planning terminal 108 to fill gaps in the 3D digital model(s).

In some embodiments, the scan pre-processing engine 202 may be configured to receive inputs for removing a portion of the gingiva represented in the 3D digital model of the dentition. For example, the scan pre-processing engine 202 may be configured to receive a selection (on a user interface of the treatment planning terminal 108) of a gingiva trimming tool which selectively removes gingival form the 3D digital model of the dentition. A user of the treatment planning terminal 108 may select a portion of the gingiva to remove using the gingiva trimming tool. The portion may be a lower portion of the gingiva represented in the digital model opposite the teeth. For example, where the 3D digital model shows a mandibular dentition, the portion of the gingiva removed from the 3D digital model may be the lower portion of the gingiva closest to the lower jaw. Similarly, where the 3D digital model shows a maxillary dentition, the portion of the gingiva removed from the 3D digital model may be the upper portion of the gingiva closest to the upper jaw.

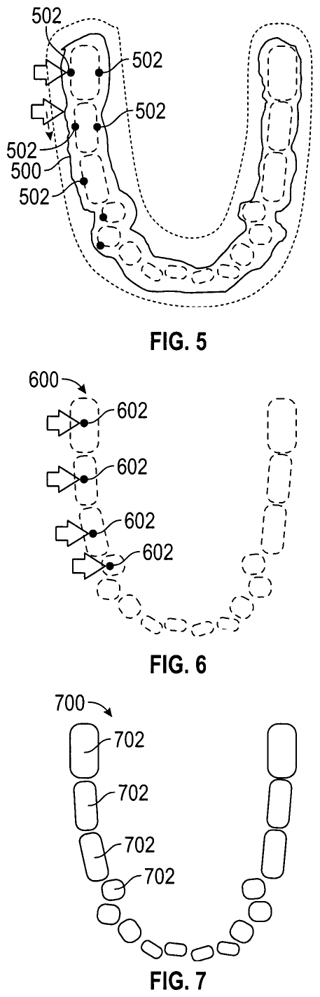

Referring now to FIG. 2 and FIG. 5, the treatment planning computing system 102 is shown to include a gingival line processing engine 204. Specifically, FIG. 5 shows a trace of a gingiva-tooth interface on the model 200 shown in FIG. 3 and FIG. 4. The gingival line processing engine 204 may be or include any device(s), component(s), circuit(s), or other combination of hardware components designed or implemented to determine, identify, or otherwise define a gingival line of the 3D digital models. The gingival line may be or include the interface between the gingiva and teeth represented in the 3D digital models. In some embodiments, the gingival line processing engine 204 may be configured to receive inputs from the treatment planning terminal 108 for defining the gingival line. The treatment planning terminal 108 may show a gingival line defining tool on a user interface which includes the 3D digital models.

The gingival line defining tool may be used for defining or otherwise determining the gingival line for the 3D digital models. As one example, the gingival line defining tool may be used to trace a rough gingival line 500. For example, a user of the treatment planning terminal 108 may select the gingival line defining tool on the user interface, and drag the gingival line defining tool along an approximate gingival line of the 3D digital model. As another example, the gingival line defining tool may be used to select (e.g., on the user interface shown on the treatment planning terminal 108) lowest points 502 at the teeth-gingiva interface for each of the teeth in the 3D digital model.

The gingival line processing engine 204 may be configured to receive the inputs provided by the user via the gingival line defining tool on the user interface of the treatment planning terminal 108 for generating or otherwise defining the gingival line. In some embodiments, the gingival line processing engine 204 may be configured to use the inputs to identify a surface transition on or near the selected inputs. For example, where the input selects a lowest point 502 (or a portion of the trace 500 near the lowest point 502) on a respective tooth, the gingival line processing engine 204 may identify a surface transition or seam at or near the lowest point 502 which is at the gingival margin. The gingival line processing engine 204 may define the transition or seam as the gingival line. The gingival line processing engine 204 may define the gingival line for each of the teeth included in the 3D digital model. The gingival line processing engine 204 may be configured to generate a tooth model using the gingival line of the teeth in the 3D digital model. The gingival line processing engine 204 may be configured to generate the tooth model by separating the 3D digital model along the gingival line. The tooth model may be the portion of the 3D digital model which is separated along the gingival line and includes digital representations of the patient's teeth.

Referring now to FIG. 2 and FIG. 6, the treatment planning computing system 102 is shown to include a segmentation processing engine 206. Specifically, FIG. 6 shows a view of the tooth model 600 generated by the gingival line processing engine 204. The segmentation processing engine 206 may be or include any device(s), component(s), circuit(s), or other combination of hardware components designed or implemented to determine, identify, or otherwise segment individual teeth from the tooth model. In some embodiments, the segmentation processing engine 206 may be configured to receive inputs (e.g., via a user interface shown on the treatment planning terminal 108) which select the teeth (e.g., points 602 on the teeth) in the tooth model 600. For example, the user interface may include a segmentation tool which, when selected, allows a user to select points 602 on each of the individual teeth in the tooth model 600. In some embodiments, the selection of each teeth may also assign a label to the teeth. The label may include tooth numbers (e.g., according to FDI world dental federation notation, the universal numbering system, Palmer notation, etc.) for each of the teeth in the tooth model 600. As shown in FIG. 6, the user may select individual teeth in the tooth model 600 to assign a label to the teeth.

Referring now to FIG. 7, depicted is a segmented tooth model 700 generated from the tooth model 600 shown in FIG. 6. The segmentation processing engine 206 may be configured to receive the selection of the teeth from the user via the user interface of the treatment planning terminal 108. The segmentation processing engine 206 may be configured to separate each of the teeth selected by the user on the user interface. For example, the segmentation processing engine 206 may be configured to identify or determine a gap between two adjacent points 602. The segmentation processing engine 206 may be configured to use the gap as a boundary defining or separating two teeth. The segmentation processing engine 206 may be configured to define boundaries for each of the teeth in the tooth model 600. The segmentation processing engine 206 may be configured to generate the segmented tooth model 700 including segmented teeth 702 using the defined boundaries generated from the selection of the points 602 on the teeth in the tooth model 600.

The treatment planning computing system 102 is shown to include a geometry processing engine 208. The geometry processing engine 208 may be or include any device(s), component(s), circuit(s), or other combination of hardware components designed or implemented to determine, identify, or otherwise generate whole tooth models for each of the teeth in the 3D digital model. Once the segmentation processing engine 206 generates the segmented tooth model 700, the geometry processing engine 208 may be configured to use the segmented teeth to generate a whole tooth model for each of the segmented teeth. Since the teeth have been separated along the gingival line by the gingival line processing engine 204 (as described above with reference to FIG. 6), the segmented teeth may only include crowns (e.g., the segmented teeth may not include any roots). The gingival line processing engine 204 may be configured to generate a whole tooth model including both crown and roots using the segmented teeth. In some embodiments, the segmentation processing engine 206 may be configured to generate the whole tooth models using the labels assigned to each of the teeth in the segmented tooth model 700. For example, the geometry processing engine 208 may be configured to access a tooth library 216. The tooth library 216 may include a library or database having a plurality of whole tooth models. The plurality of whole tooth models may include tooth models for each of the types of teeth in a dentition. The plurality of whole tooth models may be labeled or grouped according to tooth numbers.

The geometry processing engine 208 may be configured to generate the whole tooth models for a segmented tooth by performing a look-up function in the tooth library 216 using the label assigned to the segmented tooth to identify a corresponding whole tooth model. The geometry processing engine 208 may be configured to morph the whole tooth model identified in the tooth library 216 to correspond to the shape (e.g., surface contours) of the segmented tooth. In some embodiments, the geometry processing engine 208 may be configured to generate the whole tooth model by stitching the morphed whole tooth model from the tooth library 216 to the segmented tooth, such that the whole tooth model includes a portion (e.g., a root portion) from the tooth library 216 and a portion (e.g., a crown portion) from the segmented tooth. In some embodiments, the geometry processing engine 208 may be configured to generate the whole tooth model by replacing the segmented tooth with the morphed tooth model from the tooth library. In these and other embodiments, the geometry processing engine 208 may be configured to generate whole tooth models, including both crown and roots, for each of the teeth in a 3D digital model. The whole tooth models of each of the teeth in the 3D digital model may depict, show, or otherwise represent an initial position of the patient's dentition.

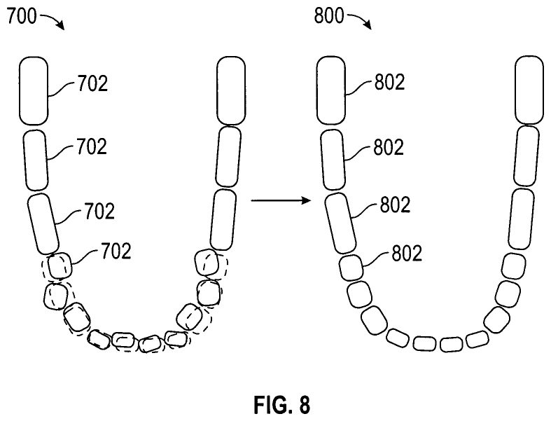

Referring now to FIG. 2, FIG. 8, and FIG. 10, the treatment planning computing system 102 is shown to include a final position processing engine 210. FIG. 8 shows one example of a target final position of the dentition from the initial position of the dentition shown in FIG. 7 from a top-down view. FIG. 10 shows one example of a target final position of the dentition from the initial position of the dentition shown in FIG. 7 from a side view. Specifically, FIG. 10 shows one example of a target final position of each of the upper and lower detentions relative to an occlusal axis, such as the longitudinal axis of each tooth (e.g., the axis extending between the upper and lower dentition), as will be described below.

The final position processing engine 210 may be or may include any device(s), component(s), circuit(s), or other combination of hardware components designed or implemented to determine, identify, or otherwise generate a final position of the patient's teeth. The final position processing engine 210 may be configured to generate the treatment plan by manipulating individual 3D models of teeth within the 3D model (e.g., shown in FIG. 7). In some embodiments, the final position processing engine 210 may be configured to receive inputs for generating the final position of the patient's teeth. The final position may be a target position of the teeth post-orthodontic treatment or at a last stage of realignment. A user of the treatment planning terminal 108 may provide one or more inputs for each tooth or a subset of the teeth in the initial 3D model to move the teeth from their initial position to their final position (shown in dot-dash). For example, the treatment planning terminal 108 may be configured to receive inputs to drag, shift, rotate, or otherwise move individual teeth to their final position, incrementally shift the teeth to their final position, etc. The movements may include lateral/longitudinal movements, rotational movements, translational movements, etc. The movements may include intrusions and/or extrusions of the teeth relative to the occlusal axis, as will be described below.

In some embodiments, the manipulation of the 3D model may show a final (or target) position of the teeth of the patient following orthodontic treatment or at a last stage of realignment via dental aligners. In some embodiments, the final position processing engine 210 may be configured to apply one or more movement thresholds (e.g., a maximum lateral and/or rotational movement for treatment) to each of the individual 3D teeth models for generating the final position. As such, the final position may be generated in accordance with the movement thresholds.

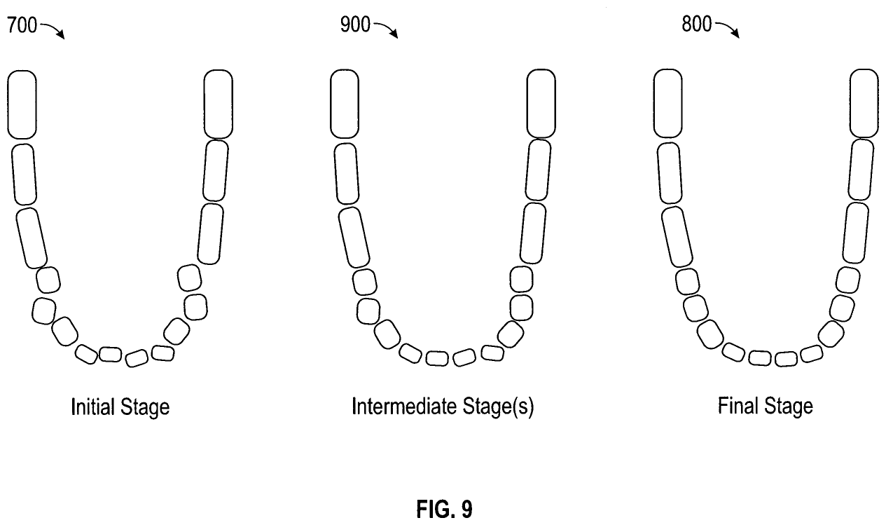

Referring now to FIG. 2 and FIG. 9, the treatment planning computing system 102 is shown to include a staging processing engine 212. Specifically, FIG. 9 shows a series of stages of the dentition from the initial position shown in FIG. 7 to the target final position shown in FIG. 8 and FIG. 10, according to an illustrative embodiment. The staging processing engine 212 may be or include any device(s), component(s), circuit(s), or other combination of hardware components designed or implemented to determine, identify, or otherwise generate stages of treatment from the initial position to the final position of the patient's teeth. In some embodiments, the staging processing engine 212 may be configured to receive inputs (e.g., via a user interface of the treatment planning terminal 108) for generating the stages. In some embodiments, the staging processing engine 212 may be configured to automatically compute or determine the stages based on the movements from the initial to the final position. The staging processing engine 212 may be configured to apply one or more movement thresholds (e.g., a maximum lateral and/or rotational movement for a respective stage) to each stage of treatment plan. The staging processing engine 212 may be configured to generate the stages as 3D digital models of the patient's teeth as they progress from their initial position to their final position. For example, and as shown in FIG. 9, the stages may include an initial stage including a 3D digital model of the patient's teeth at their initial position, one or more intermediate stages including 3D digital model(s) of the patient's teeth at one or more intermediate positions, and a final stage including a 3D digital model of the patient's teeth at the final position.

In some embodiments, the staging processing engine 212 may be configured to generate at least one intermediate stage for each tooth based on a difference between the initial position of the tooth and the final position of the tooth. For instance, where the staging processing engine 212 generates one intermediate stage, the intermediate stage may be a halfway point between the initial position of the tooth and the final position of the tooth. Each of the stages may together form a treatment plan for the patient, and may include a series or set of 3D digital models.

Following generating the stages, the treatment planning computing system 102 may be configured to transmit, send, or otherwise provide the staged 3D digital models to the fabrication computing system 106. In some embodiments, the treatment planning computing system 102 may be configured to provide the staged 3D digital models to the fabrication computing system 106 by uploading the staged 3D digital models to a patient file which is accessible via the fabrication computing system 106. In some embodiments, the treatment planning computing system 102 may be configured to provide the staged 3D digital models to the fabrication system 106 by sending the staged 3D digital models to an address (e.g., an email address, IP address, etc.) for the fabrication computing system 106.

The fabrication computing system 106 can include a fabrication computing device and fabrication equipment 218 configured to produce, manufacture, or otherwise fabricate dental aligners. The fabrication computing system 106 may be configured to receive a plurality of staged 3D digital models corresponding to the treatment plan for the patient. As stated above, each 3D digital model may be representative of a particular stage of the treatment plan (e.g., a first 3D model corresponding to an initial stage of the treatment plan, one or more intermediate 3D models corresponding to intermediate stages of the treatment plan, and a final 3D model corresponding to a final stage of the treatment plan).

The fabrication computing system 106 may be configured to send the staged 3D models to fabrication equipment 218 for generating, constructing, building, or otherwise producing dental aligners 220. In some embodiments, the fabrication equipment 218 may include a 3D printing system. The 3D printing system may be used to 3D print physical models corresponding the 3D models of the treatment plan. As such, the 3D printing system may be configured to fabricate physical models which represent each stage of the treatment plan. In some implementations, the fabrication equipment 218 may include casting equipment configured to cast, etch, or otherwise generate physical models based on the 3D models of the treatment plan. Where the 3D printing system generates physical models, the fabrication equipment 218 may also include a thermoforming system. The thermoforming system may be configured to thermoform a polymeric material to the physical models, and cut, trim, or otherwise remove excess polymeric material from the physical models to fabricate a dental aligner. In some embodiments, the 3D printing system may be configured to directly fabricate dental aligners 220 (e.g., by 3D printing the dental aligners 220 directly based on the 3D models of the treatment plan). Additional details corresponding to fabricating dental aligners 220 are described in U.S. Provisional Patent Appl. No. 62/522,847, titled “Dental Impression Kit and Methods Therefor,” filed Jun. 21, 2017, and U.S. patent application Ser. No. 16/047,694, titled “Dental Impression Kit and Methods Therefor,” filed Jul. 27, 2018, and U.S. Pat. No. 10,315,353, titled “Systems and Methods for Thermoforming Dental Aligners,” filed Nov. 13, 2018, the contents of each of which are incorporated herein by reference in their entirety.

The fabrication equipment 218 may be configured to generate or otherwise fabricate dental aligners 220 for each stage of the treatment plan. In some instances, each stage may include a plurality of dental aligners 220 (e.g., a plurality of dental aligners 220 for the first stage of the treatment plan, a plurality of dental aligners 220 for the intermediate stage(s) of the treatment plan, a plurality of dental aligners 220 for the final stage of the treatment plan, etc.). Each of the dental aligners 220 may be worn by the patient in a particular sequence for a predetermined duration (e.g., two weeks for a first dental aligner 220 of the first stage, one week for a second dental aligner 220 of the first stage, etc.).

The systems and methods discussed herein describe at least four executables performed or otherwise implemented by the final position processing engine 210 to perform a process to modify the position of one or more teeth. The executables may include a distribute executable, a leveling executable, an arch form executable, and an arch design executable. In some embodiments, the executables may be invoked by a user selecting a button, option, or portion on a user interface. When the user selects on one or more of the user interface portions, the final position processing engine 210 automatically modifies the position of the teeth to be more in line with a desired final position of the teeth. All of these features allows a user such as a medical provider or technician to move all teeth in the jaw to a final position within CAD modelling software creating a high-quality first approximation in much fewer steps than manually moving each tooth into a desired position. In some embodiments, the high quality approximation may then be used as a starting point for a final manual correction.

When the distribute user interface portion corresponding to the distribute executable is selected, the final position processing engine 210 may execute the distribute executable to perform a process to distribute the teeth along the arch curve. When the leveling user interface portion corresponding to the leveling executable is selected, the final position processing engine 210 may execute the leveling executable to perform a process to determine a cutting edge of the anterior teeth in the occlusal plane based on a previously selected guide tooth then modify the position of one or more teeth to be in line with the cutting edge. The leveling executable may cause the final position processing engine 210 to align the anterior teeth by height so that the anterior teeth are approximately the same height. In some embodiments, the leveling executable may cause the final position processing engine 210 to perform a process to move the teeth in the occlusal direction. The arch form executable may cause the final position processing engine 210 to perform a process to align the teeth in the jaw in accordance with a predetermined arch curve by moving the teeth in the mesial-distal direction. The arch design executable may cause the final position processing engine 210 to perform a process to minimize the interproximal contacts between the teeth in the jaw by moving one or more teeth in a mesial-distal or buccal-lingual direction.

Referring now to FIG. 10, an example user interface 1000 of the CAD software used to apply one or more executables described above is shown, according to an exemplary embodiment. The user interface 1000 may be displayed on one of the treatment planning terminals 108. For example, user interface 1000 may be used to cause the final position processing engine 210 to execute the distribute executable, the leveling executable, the arch form executable, and/or the arch design executable which are described in greater detail below. Additionally, further views of the user interface 1000 are shown and described in greater detail below.

In some embodiments, user interface 1000 may include user interface settings portion wherein a user (e.g., a medical provider) may select any number of settings that would modify the appearance or function of user interface 1000. For example, a user may select which view of the 3D representation of the dentition they would like to see and which features they would like displayed (grid, bounding boxes, midline, etc.). In some embodiments, user interface 1000 may also include main menu panel which allows the user to upload, save, export, and/or open a new case file.

In some embodiments, the user may also select which part of the treatment plan (e.g., final positioning, staging, etc.) they are currently working on. For example, in this case, the user would select the final positioning stage. In some embodiments, the user interface 1000 includes a 3D model 1015 of a dentition configured to display to the user the changes made to the 3D model 1015 of the dentition in real-time. In some embodiments, the user interface 1000 may include an executables user interface portion that includes user interface elements or buttons for causing the final position processing engine 210 to execute a corresponding executable. For example, user interface portion may include a distribute user interface button, an arch form user interface button, a leveling user interface button, and an arch design user interface button. When one or more of these buttons are selected by a user of the treatment planning terminal 108, which when selected by the user automatically applies the features to the 3D model 1015 of the dentition. In some embodiments, the user interface 1000 may include a history of changes made portion, which may show a list of changes made to the 3D model 1015. In some embodiments, the user interface 1000 includes a measurement portion 1035 which shows the measurements and calculations associated with each tooth as the teeth are moved following execution of the corresponding executables.

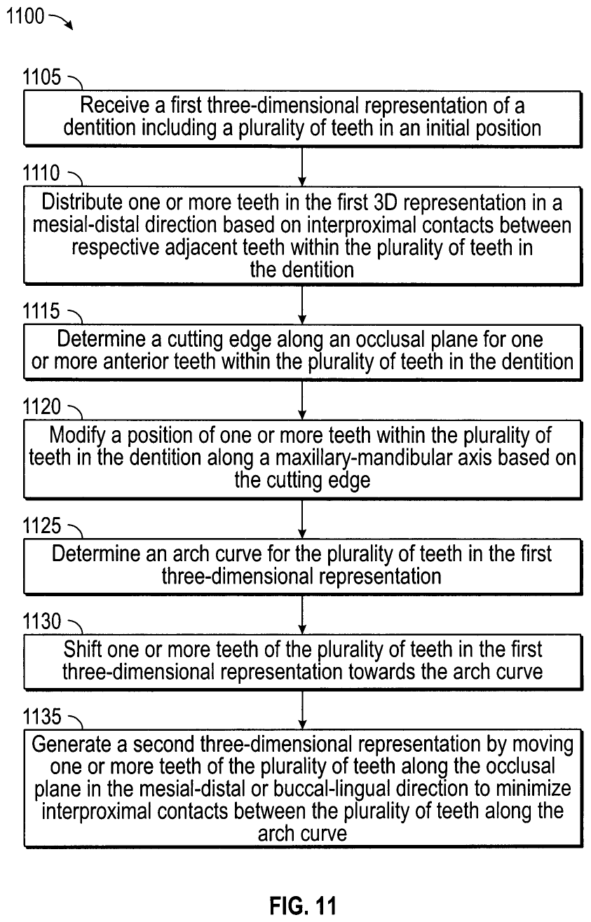

Referring now to FIG. 11, a diagram of a method 1100 of generating a 3D representation showing a final position for a plurality of teeth according to a treatment plan is shown, according to an exemplary embodiment. The method 1100 may be implemented by one or more components described above with reference to FIGS. 1-2.

At step 1105, the treatment planning computing system 102, receives a first 3D representation of a dentition including a plurality of teeth in an initial position. In some embodiments, the treatment planning computing system 102 receives the first 3D representation from the intake computing system 104. The intake computing system 104 is structured to utilize scanning devices 214 to capture an image and/or representation of one or more teeth and generate a 3D representation of that image and/or representation. In some embodiments, the treatment planning computing system 102 may receive a first 3D representation of a dentition from a scanning device, such as an intraoral scanning device which directly scans the patient's teeth. In some embodiments, the scanning device may scan impressions of a patient's teeth captured by the patient using an impression kit, to create the first 3D representation of the dentition.

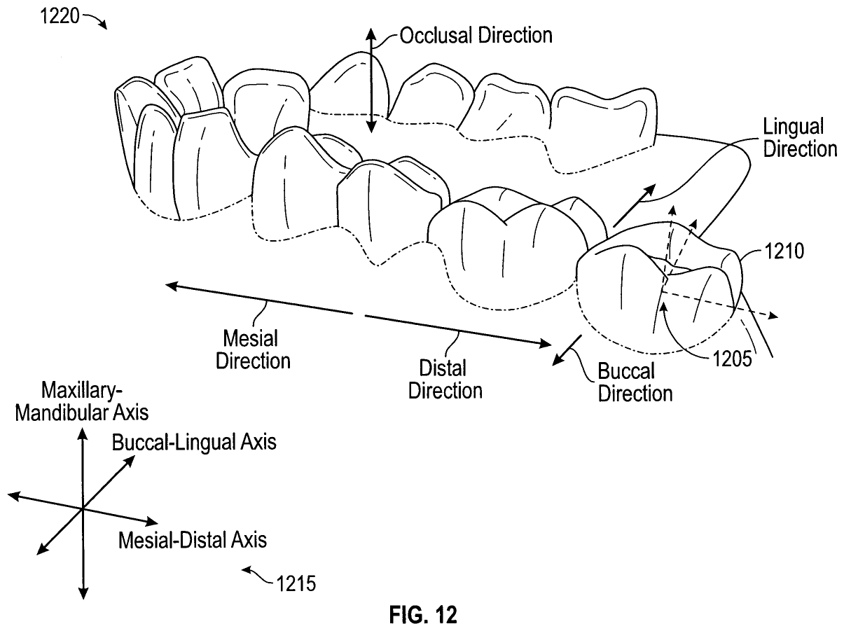

At step 1110, the treatment planning computing system 102 distributes one or more first teeth in the first 3D representation received at step 1105 in a mesial-distal direction. The mesial-distal direction generally refers to a direction away from (or towards) a midline of the dentition. In other words, distributing teeth in the mesial-distal direction refers to either moving the teeth towards a midline (e.g., towards the incisors) or away from the midline (e.g., towards the molars) as shown in FIG. 12. The treatment planning computing system 102 may distribute the teeth in the mesial-distal direction based on interproximal contacts between the respective adjacent teeth within the plurality of teeth in the dentition. In some embodiments, the final position processing engine 210 may distribute the one or more first teeth in the mesial-distal direction at step 1110. In some embodiments, the final position processing engine 210 may define the mesial-distal direction for each tooth. The final position processing engine 210 may define the mesial-distal direction locally a line connecting the two nearest points of two adjacent teeth. In other embodiments, the final position processing engine 210 may define the mesial-distal direction along a line connecting centers of two adjacent teeth. In yet other embodiments, the final position processing engine 210 may define the mesial-distal direction for each tooth according to a local coordinate system of each individual tooth. In some embodiments, the local coordinate system of each tooth differs from the coordinate system for the first 3D representation of the whole jaw. More specifically, the local coordinate system for each tooth describes the mesial, distal, buccal, lingual, and occlusal direction for each tooth. For example, the lingual direction for a tooth on one side of the patient's tongue differs from the lingual direction for a tooth on the opposite side of the patient's tongue, since the teeth are on opposite sides of the tongue. Therefore, the local coordinate system for each tooth clarifies the directions for each tooth relative to the dental arch. For example, in FIG. 12, coordinate system 1205 is the local coordinate for tooth 1210 while coordinate system 1215 is the coordinate system for the whole jaw 1220.

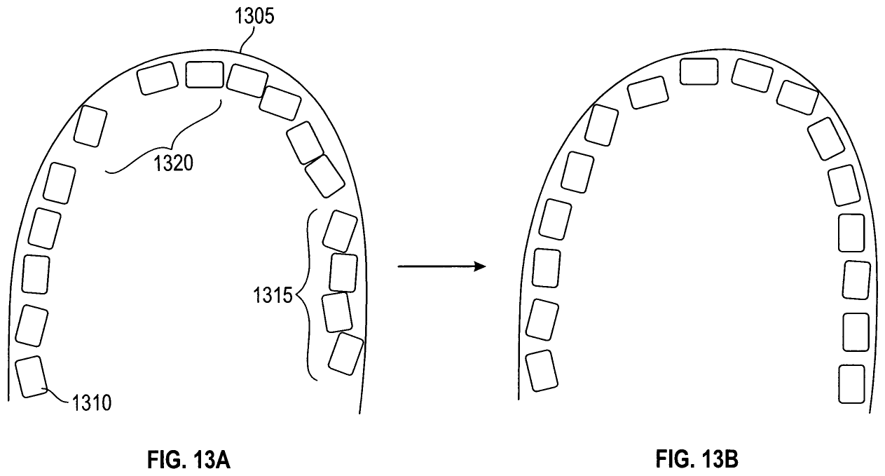

Referring now to FIGS. 13A and 13B in connection with FIG. 11, depicted are representations of a set of teeth before and after execution of a distribute executable, according to an illustrative embodiment. When the final position processing engine 210 executes the distribute executable (e.g., responsive to receiving a selection of the distribute user interface portion), the final position processing engine 210 may be configured to measure the free space (e.g., empty space within the interproximal regions of adjacent teeth in the arch) between each of the teeth, and in the jaw as a whole, in the first 3D representation of the dentition. In other words, the final position processing engine 210 may be configured to determine or quantify the gaps or spaces within the dental arch. Following determining or quantifying the gaps or spaces in the dental arch, the final position processing engine 210 may identify movement vectors for moving the teeth to distribute the gaps evenly across the dental arch.

The final position processing engine 210 may be configured to determine a value (e.g., a magnitude) and direction of movement for the one or more first teeth to distribute the spaces between the teeth in the patient's jaw. In some embodiments, several iterations are performed due to the complex shape of the teeth. For example, the process may perform four or five iterations before converging. In some embodiments, the final position processing engine 210 distributes the spaces between the teeth by computing an average space between two teeth based on the computed total space and the number of teeth in the dental arch. The final position processing engine 210 may be configured to shift each of the teeth in the mesial (and/or mesial-distal) direction such that each of the teeth have the computed average space between the adjacent two teeth. For example, FIG. 13A shows a representation of a set of teeth before execution of the distribute executable by the final position processing engine 210. As can be seen in FIG. 13A, some of the teeth 1310 in the representation are crowded too close together (e.g., at 1315), while some of the teeth are spread too far apart (e.g., at 1320). In this case, the final position processing engine 210 may measure the free space between each of the teeth 1310 and the space of the jaw 1305 and determine a value and vector of movement for each tooth 1310, to evenly spread out the teeth within the jaw 1305. FIG. 13B shows the representation of the set of teeth after the distribution tool has been applied. As can be seen from FIG. 13B, the teeth 1310 are more evenly distributed after the distribute tool has been applied by the final position processing engine 210.

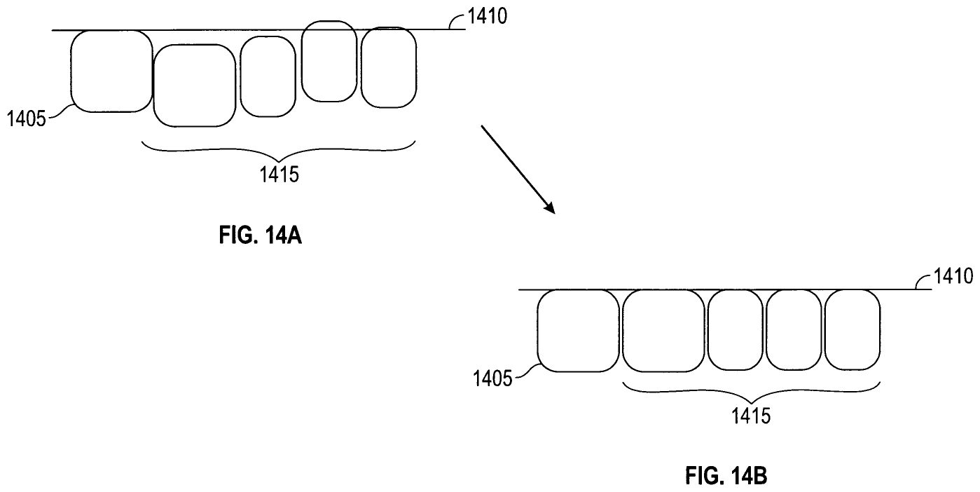

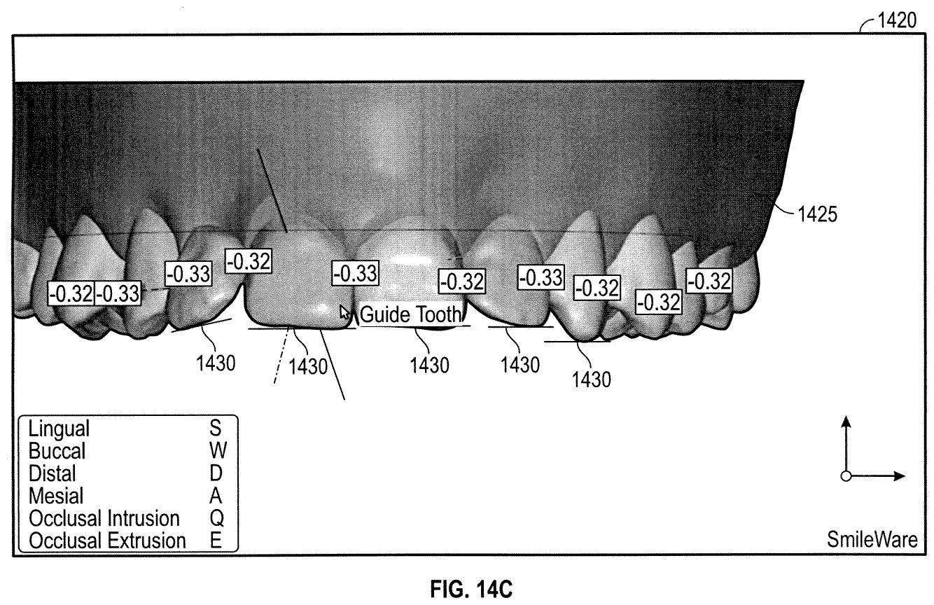

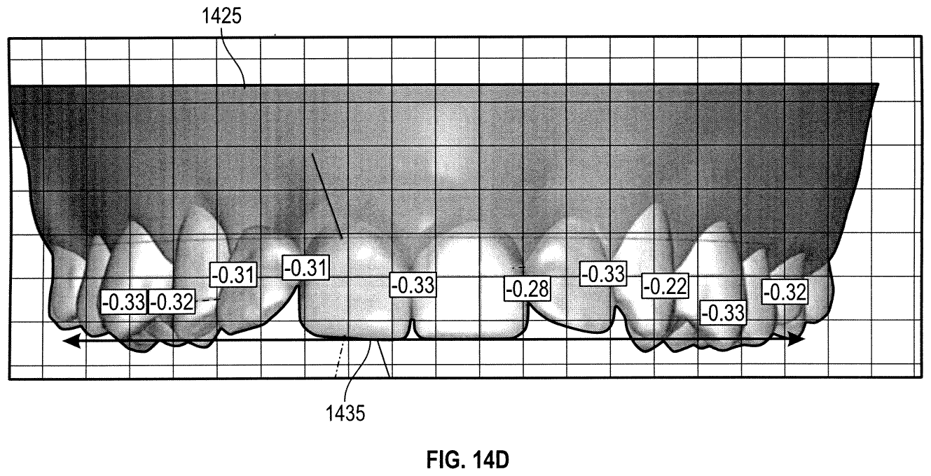

At step 1115, the treatment planning computing system 102 determines a cutting edge along the occlusal plane for one or more posterior teeth with the plurality of teeth in the dentition. Referring to FIGS. 14A and 14B in connection with FIG. 11, depicted are representations of a set of teeth before and after execution of a leveling executable, according to an illustrative embodiment. The cutting edge may be defined as a leveling plane by which one or more teeth may be adjusted in the occlusal direction to be on the same height level as the cutting edge. The occlusal direction may be defined as generally extending parallel to the maxillary-mandibular axis as shown in FIG. 12 (e.g., perpendicular to an occlusal plane). Typically, having all the teeth within a patient's mouth to be relatively at the same level (e.g., height on the occlusal plane) ensures that pressure and force is equally distributed within the patient's mouth. Ensuring that pressure and force is equally distributed in a patient's mouth may prevent one or more teeth in a patient's mouth from wearing out (or breaking), and may also be more aesthetically pleasing. In some embodiments, the final position processing engine 210 determines the cutting edge upon receiving a selection within an example user interface, such example user interface 1000. More specifically, the final position processing engine 210 may request that the user selects a guide tooth from the plurality of teeth within the first 3D representation of the dentition. The guide tooth may be a reference tooth which the final position processing engine 210 uses to define the cutting edge. The guide tooth may be used to set the level (e.g., height) of the cutting edge. For example, FIG. 14A shows guide tooth 1405 which sets the cutting edge 1410 by which other teeth 1415 may set on the same level as the cutting edge. More specifically, the final position processing engine 210 sets the height of the cutting edge in the occlusal plane equal to the height of the guide tooth relative to the occlusal plane. In some embodiments, the rear molars (i.e., posterior teeth) may be selected as the guide tooth.

Referring now to FIG. 14C and FIG. 14D, depicted is a user interface 1420 for selecting a guide tooth on a 3D model 1425 of a dentition for the leveling executable, and a view of the 3D model 1425 following execution of the leveling executable, respectively, according to illustrative embodiments. In some embodiments, the user interface 1420 may include a button or other user interface element for executing the leveling executable. In some embodiments, the user interface 1000 may include the button or user interface element for executing the leveling executable. A user may select the user interface element (e.g., on the user interface 1000, 1420). Responsive to selecting the user interface element, the user may prompted to select a guide tooth (as shown in FIG. 14C). As described above, the guide tooth may be used to define the cutting edge. As shown in FIG. 14C, the guide tooth may be an anterior tooth of the 3D model 1425 of the dentition. The guide tooth may include an occlusal edge 1430 (e.g., an edge which is closest to an occlusal plane for the dentition). The occlusal edge 1430 of the selected guide tooth may define the cutting edge of the dentition.

At step 1120, the treatment planning computing system 102 modifies a position of one or more teeth in the dentition along a maxillary-mandibular axis (as shown in FIG. 12) based on the cutting edge determined at step 1115. In some embodiments, the final position processing engine 210 may be configured to execute the leveling executable to automatically modify the vertical position of one or more anterior teeth in the occlusal direction (as described above) so that the anterior teeth may be at the same level as the cutting edge determined at step 1115. More specifically, the final position processing engine 210 measures the difference between the cutting edge (e.g., cutting edge 1410) and an occlusal surface of the other teeth in the 3D representation of the dentition (e.g., teeth 1415). The final position processing engine 210 moves the position of the teeth (e.g., teeth 1415) to minimize the difference between the occlusal surface of the teeth and the cutting edge.

FIG. 14D shows a view of the 3D model 1425 following selection of the guide tooth. The final position processing engine 210 may be configured to shift or move other teeth in the 3D model 1425 of the dentition based on the selected guide tooth. In some embodiments, the final position processing engine 210 may be configured to project the cutting edge 1435 along the 3D model 1425 (e.g., along or parallel to the occlusal plane). The final position processing engine 210 may be configured to compute a difference between an occlusal edge for other teeth in the 3D model 1425 relative to the projected cutting edge 1435. The final position processing engine 210 may be configured to move each of the other teeth in the 3D model 1425 of the dentition based on the computed difference (e.g., to minimize a distance between the cutting edge 1435 and the respective occlusal edge of the other teeth). As shown in FIG. 14D, the occlusal edge 1430 (shown in FIG. 14C) of the teeth in the 3D model 1425 may be located substantially along the cutting edge 1435 following execution of the leveling executable.

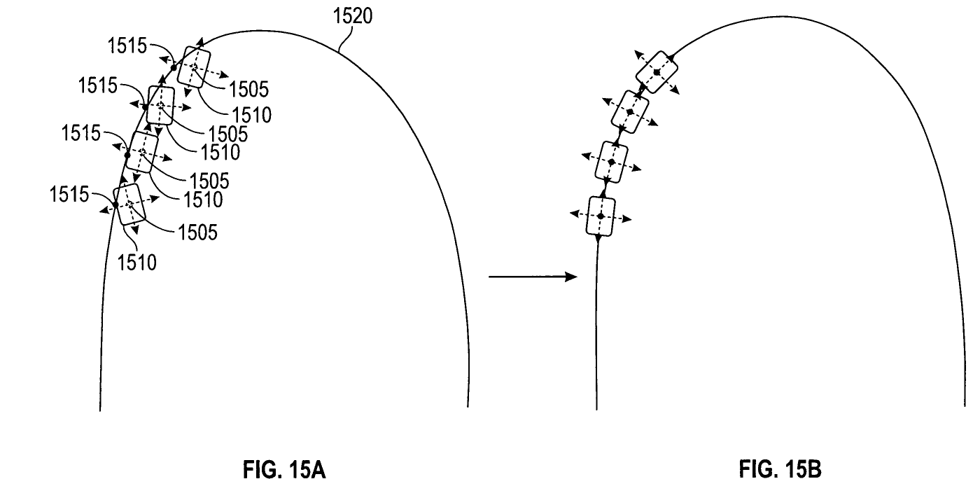

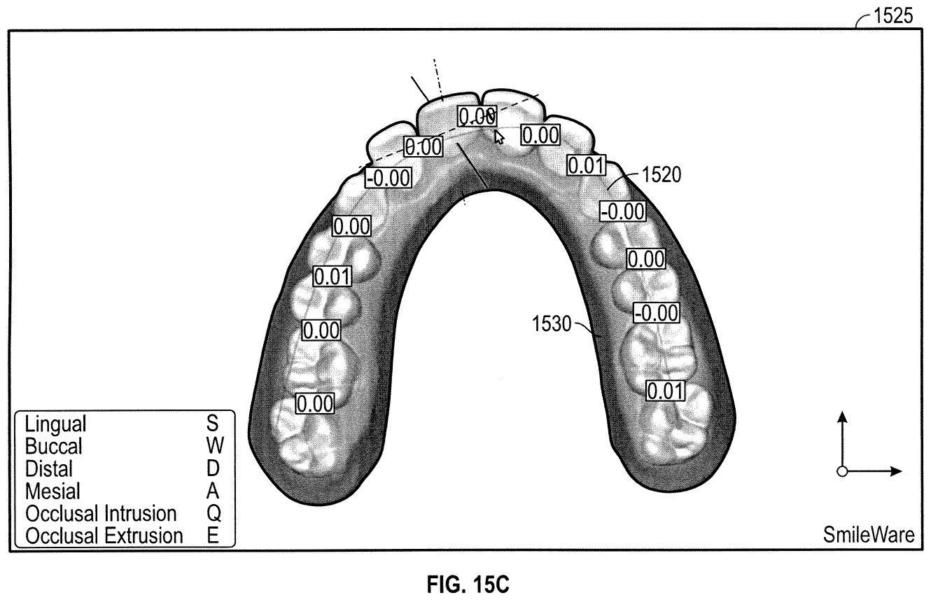

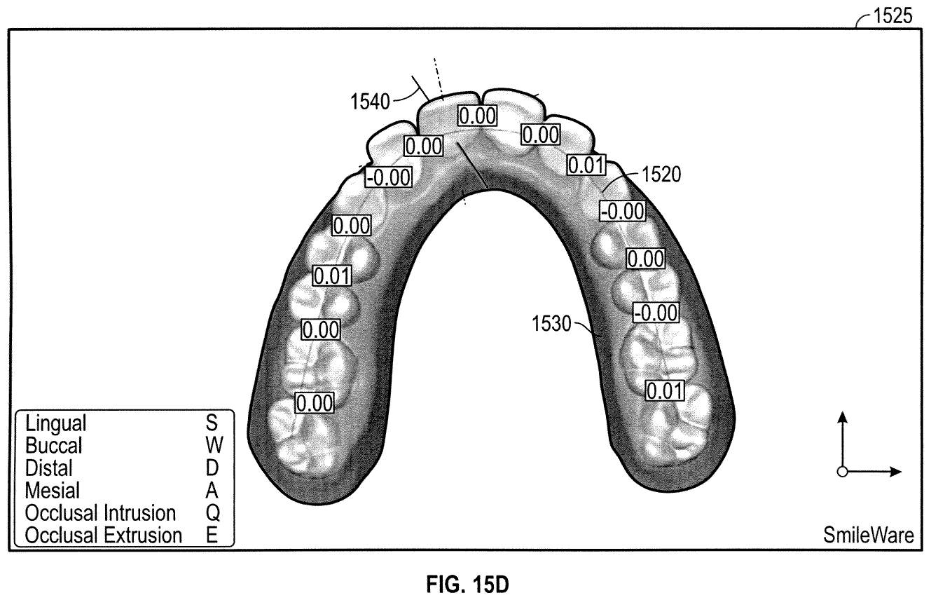

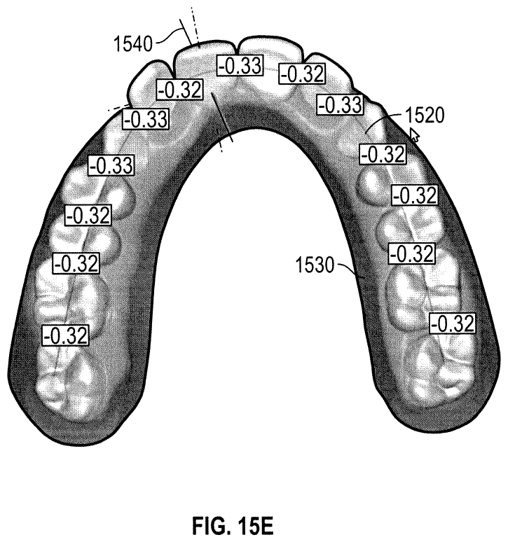

At step 1125, the treatment planning computing system 102 determines an arch curve (e.g., arch curve 1520) for the plurality of teeth in the first 3D representation. Referring now to FIGS. 15A and 15B, depicted are representations of a set of teeth before and after execution of an arch form executable, according to an illustrative embodiment. In some embodiments, the treatment planning computing system 102 determines or computes the arch curve as a second order curve. A second order curve may be defined as a plane curve whose rectangular Cartesian coordinates satisfy an algebraic equation of the second degree. In other embodiments, the treatment planning computing system 102 determines or computes the arch curve as a fourth order curve. Similarly, a fourth order curve may be defined as a plane curve whose regular Cartesian coordinates satisfy an algebraic equation of the fourth degree. the treatment planning computing system 102 may determine or compute the arch curve from an approximation of the centers of the plurality of teeth within the first 3D representation. For example, the treatment planning computing system 102 may be configured to use each of the centers of the plurality teeth for approximating a curve (e.g., a second or fourth order curve) which is defined by the centers of the teeth. In some embodiments, the final position processing engine 210 measures the length, width, and height of each tooth in the plurality of teeth in the first 3D representation to determine an approximate center 1505 of each respective tooth 1510. The final position processing engine 210 may be configured to compute or derive the arch curve 1520 using the centers 1505 of each tooth 1510.

Referring now to FIG. 15C, depicted is a user interface 1525 for defining an arch curve 1520 for a 3D model 1530 of a dentition, according to an illustrative embodiment. The user interface 1525 may include an “Auto ArchShape” user interface element. Upon selecting the user interface element, the final position processing engine 210 may be configured to automatically generate or determine the arch curve 1520 (which may be performed as described above based on the centers or centroids of the teeth in the 3D model 1530 as described above). In some embodiments, a user may perform one or more adjustments to the arch curve 1520. For example, the final position processing engine 210 may be configured to receive one or more adjustments to the arch curve 1520 by receiving a selection of a point along the arch curve 1520 and dragging the point in a direction. As the point is dragged, the arch curve 1520 may correspondingly move. The arch curve 1520 may bow out (e.g., as the point is dragged outwardly in the buccal direction), flex in (e.g., as the point is dragged inwardly in the lingual direction), etc. FIG. 15D shows the user interface 1525 including the 3D model 1530 following defining the arch curve 1520, according to an illustrative embodiment. As shown in FIG. 15D, the arch curve 1520 substantially follows the center of the teeth. Following defining the arch curve 1520, the user may select the user interface element to cause the final position processing engine 210 to execute the arch shape executable.

Referring back to FIG. 11, at step 1130, the treatment planning computing system 102 shifts one or more teeth of the plurality of teeth in the first 3D representation towards the arch curve. More specifically, when the final position processing engine 210 executes the arch form executable (e.g., responsive to receiving a selection of the user interface element 1535 on the user interface 1525), the final position processing engine 210 may be configured to project the centers 1505 of the one or more teeth 1510 on the arch curve 1520 created at step 1125. The final position processing engine 210 may shift the one or more teeth towards the arch curve 1520 so that centers 1505 of the teeth 1510 match up with the projected centers of the teeth 1510 on the arch curve 1520. In other words, the final position processing engine 210 may be configured to shift the teeth 1510 such that the centers 1505 overlap or substantially overlap the arch curve 1520.

In some embodiments, the final position processing engine 210 may turn, pivot, or otherwise rotate some of the shifted teeth 1510 (e.g., in the occlusal direction or about the maxillary-mandibular axis). The final position processing engine 210 may be configured to rotate the teeth 1510 such that a local buccal-lingual direction of the teeth 1510 is normal to the arch curve 1520 at the point where the center 1505 of the tooth 1510 is projected to on the arch curve 1520. In some embodiments, the final position processing engine 210 may be configured to measure an angle of projected center 1505 of the tooth 1510 in relation to the arch curve 1520 to determine a normal direction of the projected center 1505 on the arch curve 1520. Once the final position processing engine 210 shifts the position of the tooth 1510 onto arch curve 1520, the final position processing engine 210 may be configured to rotates the tooth 1510 along the mesial-distal axis and/or the buccal-lingual axis according to the normal direction of the projected center 1505. As mentioned above, each tooth has its own local coordinate system (e.g., including a local buccal-lingual axis). In some embodiments, the final position processing engine 210 may be configured to measure an angle of a local buccal-lingual axis of the tooth 1510 (e.g., following shifting the tooth 1510 so that the center 1505 resides on the arch curve 1520) relative to a normal of the arch curve 1520 at the center 1505. The final position processing engine 210 may be configured to rotate the tooth 1510 to minimize the angle between the local buccal-lingual axis and the normal. Following shifting and rotating the teeth 1510, the teeth 1510 may be distributed more evenly on the arch curve 1520 and have an orientation having local coordinates which align with the arch curve 1520. For example, FIG. 15B demonstrates the results of modifying the position of one or more teeth 1510 responsive to executing the arch form executable as described above.

Referring to FIG. 15E, depicted is a view of the 3D model 1530 following execution of the arch form executable, according to an illustrative embodiment. As shown in FIG. 15E, each of the teeth 1510 in the 3D model 1530 may be located along the arch curve 1520. Additionally, a local coordinate system for the teeth 1510 may substantially align with the arch curve 1520. For example, for tooth 1510a, prior to execution of the arch form executable (as shown in FIG. 15D), a local buccal-lingual axis 1540a for the tooth 1510a may not be normal to the arch curve 1520. However, following execution of the arch form executable, the local buccal-lingual axis 1540a for the tooth 1510a may be substantially normal to the arch curve 1520. The local buccal-lingual axis for other teeth 1510 in the 3D model the dental arch may similarly be normal to the arch curve 1520 following execution of the arch form executable.

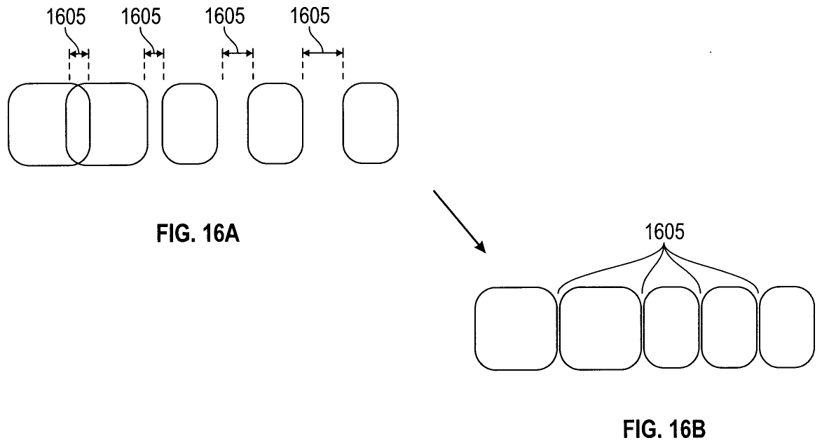

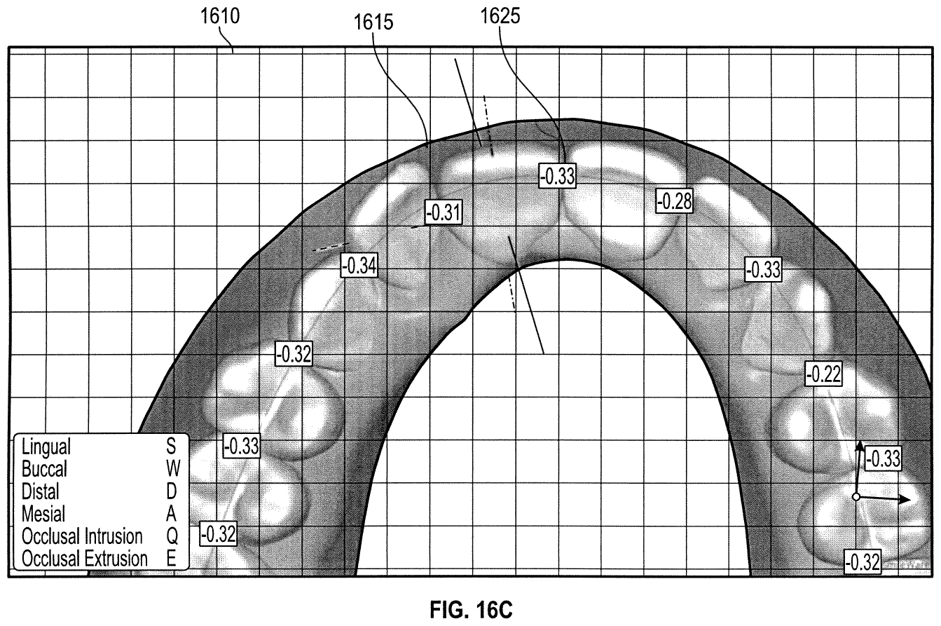

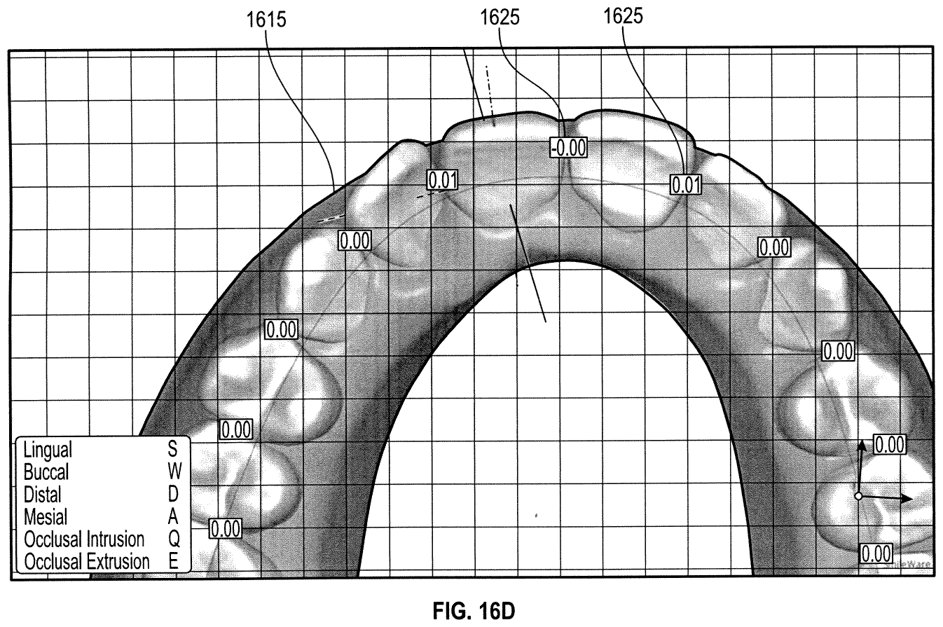

Referring back to FIG. 11, at step 1135, the treatment planning computing system 102 generates a second 3D representation of the dentition including a plurality of teeth in a final position by moving teeth 1510 along the occlusal plane in the mesial-distal or buccal-lingual direction. Specifically, referring to FIG. 16A and FIG. 16B with reference to FIG. 11, depicted are representations of a set of teeth before and after execution of an arch design executable, according to an illustrative embodiment. In some embodiments, the final position processing engine 210 may be configured to move the teeth in the mesial-distal or buccal-lingual direction to modify interproximal contacts 1605 between the teeth along the arch curve 1520. The interproximal contacts 1605 may be defined as the space (or collisions) between the plurality of teeth. For example, FIG. 16A shows interproximal contacts 1605a-1605d. As shown in FIG. 16A, some interproximal contacts 1605 (such as interproximal contacts 1605b-1605d) may include gaps or spaces between teeth, whereas other interproximal contacts 1605 (such as interproximal contact 1605a) may include collisions. Collisions, as described herein, refer to an overlap, intrusion, or intersection between two or more adjacent teeth. In some embodiments, the final position processing engine 210 may adjust or modify the interproximal contacts 1605 between the one or more teeth by measuring the distance between each tooth. The final position processing engine 210 may be configured to minimize the interproximal distance to a distance (e.g., greater than or equal to zero). The final position processing engine 210 may be configured to minimize the interproximal distance by moving the tooth along the occlusal plane in the mesial-distal or buccal-lingual direction (as defined in FIG. 12). In some embodiments, the final position processing engine 210 may minimize the interproximal distance to decrease the interproximal contact between the teeth based on a predetermined threshold. For example, clinical standards may set a threshold that defines an ideal interproximal contact between each tooth (which may be between, for example, 0.0 and 0.2 mm). The final position processing engine 210 may modify the position of one or more teeth based on the clinical standards.

In some embodiments, the final positon processing engine 210 moves the one or more teeth of the plurality of teeth in the occlusal plane while minimizing displacement of each tooth in the mesial-distal and buccal-lingual directions. The final position processing engine 210 may minimize displacement of each tooth in the mesial-distal and buccal-lingual directions such that the centers of the teeth are substantially located on the arch curve. FIG. 16B shows the one or more teeth after being modified in order to minimize interproximal contact between the teeth. As shown in FIG. 16B, the teeth may be shifted such that interproximal space between the teeth are minimized.

Referring now to FIG. 16C and FIG. 16D, depicted is a user interface 1610 including a 3D model 1615 for executing the arch design executable, and the 3D model 1615 following execution of the arch design executable, according to an illustrative embodiment. In some embodiments, the 3D model 1615 may include overlays 1625 representing the interproximal contacts between adjacent teeth. As shown in the 3D model 1615 in FIG. 16C, each of the interproximal contacts may be collisions. The overlays 1625 may represented between each of the teeth in the 3D model 1615. In some embodiments, where an interproximal contact is a collision, the corresponding overlay 1625 may be bounded, highlighted, or otherwise emphasized to indicate or otherwise identify the collision. In some embodiments, the user interface 1610 may include a user interface element. The user interface element may include an “Arch Design” button. Upon selecting the user interface element, the final position processing engine 210 may be configured to execute the arch design executable to automatically modify a position of the teeth in the 3D model 1615. As shown in FIG. 16D, each of the teeth in the 3D model 1615 may have an interproximal contact of between 0.00 mm and 0.01 mm (as shown in the overlays 1625). In some embodiments, the user interface may further include shading to depict or represent the interproximal contacts. The shading may be located along an interproximal region (e.g., a space between two teeth) to represent the interproximal contacts. The shading may be colored to represent whether the interproximal contact is a gap or space (e.g., shaded in blue), a collision (e.g., shaded in red), or optimal (e.g., shaded in green).

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (e.g., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the F. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the systems, apparatuses, and methods shown in the various exemplary embodiments is illustrative only. Additionally, any element disclosed in one embodiment may be incorporated or utilized with any other embodiment disclosed herein. For example, any of the exemplary embodiments described in this application can be incorporated with any of the other exemplary embodiment described in the application. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A method, comprising:
receiving, by one or more processors, a first three-dimensional (3D) representation of a dentition in an initial position, the first 3D representation including representations of a plurality of teeth of the dentition;
distributing, by the one or more processors, one or more first teeth in the first 3D representation in a mesial-distal direction based on interproximal contacts between respective adjacent teeth of the plurality of teeth in the dentition;
modifying, by the one or more processors, a position of one or more second teeth of the plurality of teeth along a maxillary-mandibular axis based on a determined cutting edge;
shifting, by the one or more processors, one or more third teeth of the plurality of teeth in the first 3D representation towards a determined arch curve; and
generating, by the one or more processors, a second 3D representation by moving one or more fourth teeth of the plurality of teeth along the occlusal plane in a mesial-distal or buccal-lingual direction to minimize interproximal contacts between the plurality of teeth along the arch curve.

2. The method of claim 1, wherein at least one of the one or more first teeth, the one or more second teeth, the one or more third teeth, and the one or more fourth teeth are common teeth.

3. The method of claim 1, wherein the one or more second teeth are anterior teeth.

4. The method of claim 1, wherein determining the arch curve for the plurality of teeth comprises:
determining, by the one or more processors, a center for each of the plurality of teeth in the dentition;
computing, by the one or more processors, one or more second or fourth order curves to the centers determined for the plurality of teeth; and
determining, by the one or more processors, the arch curve using the one or more second or fourth order curves.

5. The method of claim 4, wherein shifting the one or more third teeth towards the arch curve comprises shifting the one or more third teeth such that the determined center for the one or more third teeth substantially overlaps the arch curve.

6. The method of claim 1, wherein shifting the one or more third teeth towards the arch curve comprises rotating the one or more third teeth such that a local buccal-lingual direction of the one or more third teeth matches a local buccal-lingual direction for the arch curve.

7. The method of claim 1, wherein distributing the one or more first teeth comprises:
computing, by the one or more processors, a movement vector in a mesial direction for each of the one or more teeth based on a free space in a jaw of the dentition.

8. The method of claim 7, wherein the movement vector is computed based on at least one of a first line connecting nearest points between the one or more first teeth and an adjacent tooth, a second line connecting a center of the one or more first teeth and the adjacent tooth, or a local coordinate system for the one or more first teeth.

9. The method of claim 1, further comprising:
receiving, by the one or more processors, from a treatment planning terminal, one or more adjustments to the second 3D representation; and
updating, by the one or more processors, the second 3D representation based on the one or more adjustments received from the treatment planning terminal.

10. A treatment planning system, comprising:
one or more processors; and
memory storing instructions that, when executed by the one or more processors, cause the one or more processors to:
receive a first three-dimensional (3D) representation of a dentition in an initial position, the first 3D representation including representations of a plurality of teeth of the dentition;
distribute one or more first teeth in the first 3D representation in a mesial-distal direction based on interproximal contacts between respective adjacent teeth of the plurality of teeth in the dentition;
modify a position of one or more second teeth of the plurality of teeth along a maxillary-mandibular axis based on a determined cutting edge;
shift one or more third teeth of the plurality of teeth in the first 3D representation towards a determined arch curve; and
generate a second 3D representation by moving one or more fourth teeth of the plurality of teeth along the occlusal plane in a mesial-distal or buccal direction to minimize interproximal contacts between the plurality of teeth along the arch curve.

11. The treatment planning system of claim 10, wherein at least some of the one or more first teeth, the one or more second teeth, the one or more third teeth, and the one or more fourth teeth are common teeth.

12. The treatment planning system of claim 10, wherein the one or more second teeth are anterior teeth.

13. The treatment planning system of claim 10, wherein determining the arch curve for the plurality of teeth comprises:
determining a center for each of the plurality of teeth in the dentition;
computing one or more second or fourth order curves to the centers determined for the plurality of teeth; and
determining the arch curve using the one or more second or fourth order curves.

14. The treatment planning system of claim 13, wherein shifting the one or more third teeth towards the arch curve comprises shifting the one or more third teeth such that the determined center for the one or more third teeth substantially overlaps the arch curve.

15. The treatment planning system of claim 10, wherein shifting the one or more third teeth towards the arch curve comprises rotating the one or more third teeth such that a local buccal-lingual direction of the one or more third teeth matches a local buccal-lingual direction for the arch curve.

16. The treatment planning system of claim 10, wherein distributing the one or more first teeth comprises computing a movement vector in a mesial direction for each of the one or more teeth based on a free space in a jaw of the dentition.

17. The treatment planning system of claim 10, wherein the movement vector is computed based on at least one of a first line connecting nearest points between the one or more first teeth and an adjacent tooth, a second line connecting a center of the one or more first teeth and the adjacent tooth, or a local coordinate system for the one or more first teeth.

18. The treatment planning system of claim 10, wherein the instructions further cause the one or more processors to:
receive, from a treatment planning terminal, one or more adjustments to the second 3D representation; and
update the second 3D representation based on the one or more adjustments received from the treatment planning terminal.

19. A non-transitory computer readable medium storing instructions that, when executed by one or more processors, cause the one or more processors to:
receive a first three-dimensional (3D) representation of a dentition in an initial position, the first 3D representation including representations of a plurality of teeth of the dentition;
distribute one or more first teeth in the first 3D representation in a mesial-distal direction based on interproximal contacts between respective adjacent teeth of the plurality of teeth in the dentition;
modify a position of one or more second teeth of the plurality of teeth along a maxillary-mandibular axis based on a determined cutting edge;
shift one or more third teeth of the plurality of teeth in the first 3D representation towards a determined arch curve; and
generate a second 3D representation by moving one or more fourth teeth of the plurality of teeth along the occlusal plane in a mesial-distal or buccal direction to minimize interproximal contacts between the plurality of teeth along the arch curve.

20. The non-transitory computer readable medium of claim 19, wherein the instructions further cause the one or more processors to:
receive, from a treatment planning terminal, one or more adjustments to the second 3D representation; and
update the second 3D representation based on the one or more adjustments received from the treatment planning terminal.
